(19) United States
(12) Patent Application Publication
(10) Pub. No.: US 2025/0317991 A1
(43) Pub. Date: Oct. 9, 2025

(54) RACH SELECTION AND FALL BACK MECHANISMS IN SUBBAND FULL DUPLEX NETWORKS

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US)

(21) Appl. No.: 18/628,467

(22) Filed: Apr. 5, 2024

(51) Int. Cl. H04W 74/0836; H04B 17/318; H04L 5/14; H04W 74/08

(52) U.S. Cl. CPC H04W 74/0836; H04B 17/328; H04L 5/14; H04W 74/0891

(57) ABSTRACT

Method and apparatus for RACH selection and fall back mechanisms in SBFD networks. The apparatus measures a RSRP of a SSB in comparison with at least a first threshold. The apparatus selects a RACH configuration based at least on a duplex operation or a RACH type and further based on a measurement value of the RSRP in view of at least the first threshold. The apparatus communicates with a network entity based on the RACH configuration selected based at least on the duplex operation or the RACH type. The apparatus selects the RACH type after selection of the duplex operation, where the RACH type comprises a 4-step RACH or a 2-step RACH.

### TECHNICAL FIELD

The present disclosure relates generally to communication systems, and more particularly, to a configuration for random access channel (RACH) selection and fall back mechanisms in subband full duplex (SBFD) networks.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a user equipment (UE). The device may be a processor and/or a modem at a UE or the UE itself. The apparatus measures a reference signal received power (RSRP) of a synchronization signal block (SSB) in comparison with at least a first threshold. The apparatus selects a random access channel (RACH) configuration based at least on a duplex operation or a RACH type and further based on a measurement value of the RSRP in view of at least the first threshold. The apparatus communicates with a network entity based on the RACH configuration selected based at least on the duplex operation or the RACH type.

In an aspect of the disclosure, a method, a computer-readable medium, and an apparatus are provided. The apparatus may be a device at a network node. The device may be a processor and/or a modem at a network node or the network node itself. The apparatus provides a random access channel (RACH) selection configuration comprising instructions to select a RACH configuration based at least on a duplex operation or a RACH type and further based on a measurement value of a reference signal received power (RSRP) in view of at least a first threshold. The apparatus provides a synchronization signal block (SSB) for a user equipment (UE) to measure the RSRP of the SSB in comparison with at least the first threshold. The apparatus communicates with the UE based on the RACH configuration selected by the UE based at least on the duplex operation or the RACH type.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating RACH configuration parameters.

FIG. 5 is a diagram illustrating an example of random access in SBFD symbols.

FIG. 6 is a diagram illustrating example scenarios of RACH types and duplex types availability.

FIG. 7 is a diagram illustrating an example of a selection of a RACH configuration.

FIG. 8 is a diagram illustrating another example of a selection of a RACH configuration.

FIG. 9 is a call flow diagram of signaling between a UE and a base station.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a flowchart of a method of wireless communication.

FIG. 14 is a diagram illustrating an example of a hardware implementation for an example network entity.

FIG. 15A and FIG. 15B illustrate example aspects of a random access procedure.

FIGS. 16A, 16B, 16C, and 16D illustrate various modes of full duplex communication.

FIG. 17 illustrates examples of in-band full-duplex (IBFD) and sub-band frequency divisional duplex resources.

FIG. 18 is a diagram illustrating an example sub-band full-duplex (SBFD) operation.

### DETAILED DESCRIPTION

In wireless communications, if random access is allowed in SBFD symbols for SBFD-aware UEs, the random access may potentially reduce the random access latency, reduce the PRACH collision probability, or improve the coverage of PRACH and message 3 (Msg3). PRACH and Msg3 transmissions in uplink subband in SBFD symbols may cause UE-to-UE cross link interference which may impact system performance. The RACH configuration may be indicated in SIB1 and may be used for initial access and for other random access scenarios. The RACH configuration may determine the parameters utilized to determine the RACH occasions (ROs) number of preambles, the association between SSBs and ROs, or information about time domain allocation and periodicity of ROs.

In SBFD slots, the UE may have two sets of RACH occasions, one that is used by SBFD aware UE and one for non-SBFD aware UE. These two sets may come from the same configuration but with different validation rules or may come from two separate configurations which eventually form two sets. The UE may have up to four RACH sets or configurations: half-duplex 4-step RACH, half-duplex 2-step RACH, full duplex 4-step RACH, or full duplex 2-step RACH. Fall back mechanisms from 2-step to 4-step RACH may be based on a maximum number of attempts in 2-step RACH and if exceeded the UE falls back to 4-step RACH. It would be desirable for fall back under the four RACH sets or configurations to account for full duplex sets or configurations.

Aspects presented herein provide a configuration for RACH selection and fall back mechanisms in SBFD networks. For example, a UE may select a RACH configuration based at least on a duplex operation (e.g., full duplex or half duplex) or a RACH type (e.g., 2-step or 4-step), such that a fall back mechanism may include duplex mode configurations.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

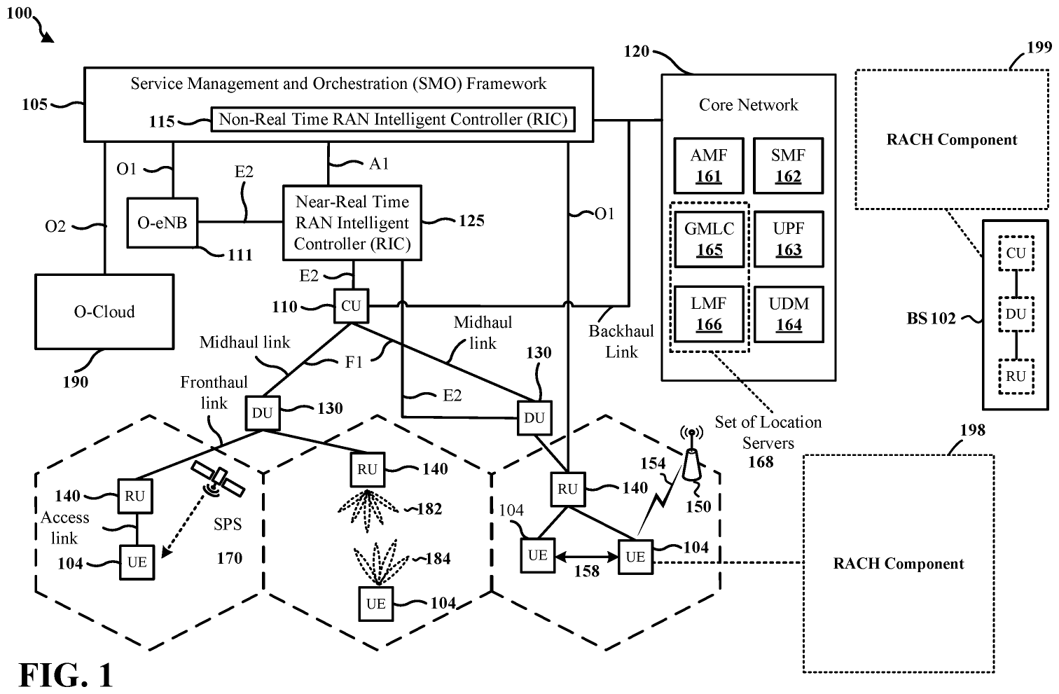

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a RACH component 198 that may be configured to measure a RSRP of a SSB in comparison with at least a first threshold; select a RACH configuration based at least on a duplex operation or a RACH type and further based on a measurement value of the RSRP in view of at least the first threshold; and communicate with a network entity based on the RACH configuration selected based at least on the duplex operation or the RACH type.

Referring again to FIG. 1, in certain aspects, the base station 102 may include a RACH component 199 that may be configured to provide a RACH selection configuration comprising instructions to select a RACH configuration based at least on a duplex operation or a RACH type and further based on a measurement value of a RSRP in view of at least a first threshold; provide a SSB for a UE to measure the RSRP of the SSB in comparison with at least the first threshold; and communicate with the UE based on the RACH configuration selected by the UE based at least on the duplex operation or the RACH type.

Although the following description may be focused on 5G NR, the concepts described herein may be applicable to other similar areas, such as LTE, LTE-A, CDMA, GSM, and other wireless technologies.

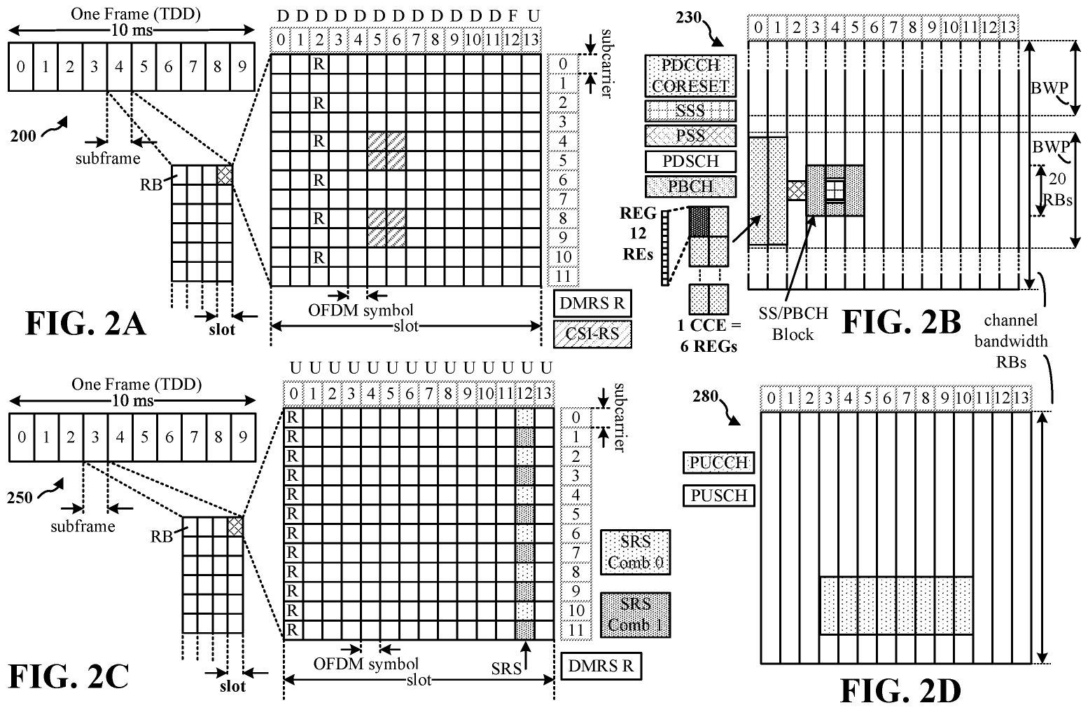

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control l information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[KHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

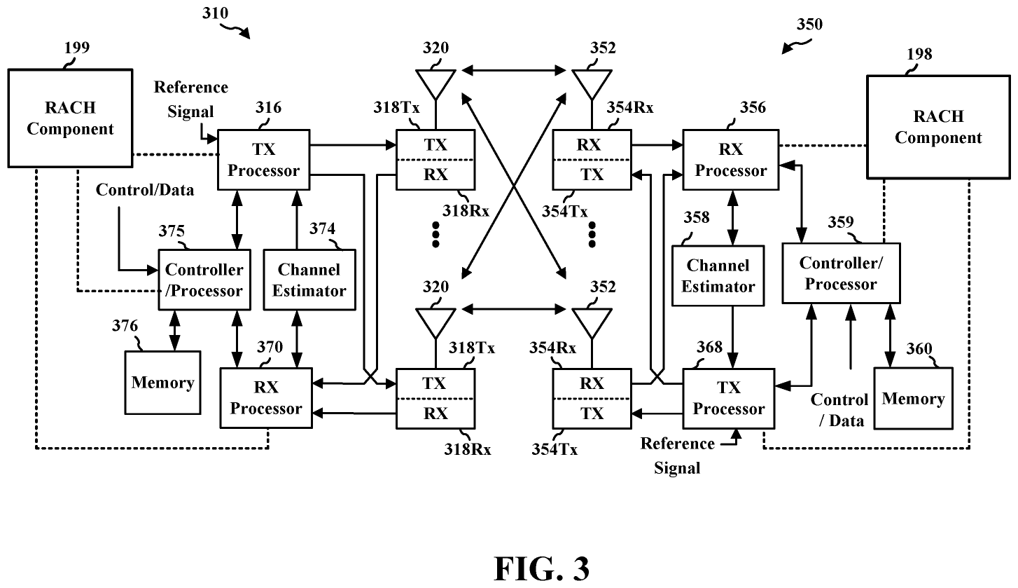

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the RACH component 198 of FIG. 1.

At least one of the TX processor 316, the RX processor 370, and the controller/processor 375 may be configured to perform aspects in connection with the RACH component 199 of FIG. 1.

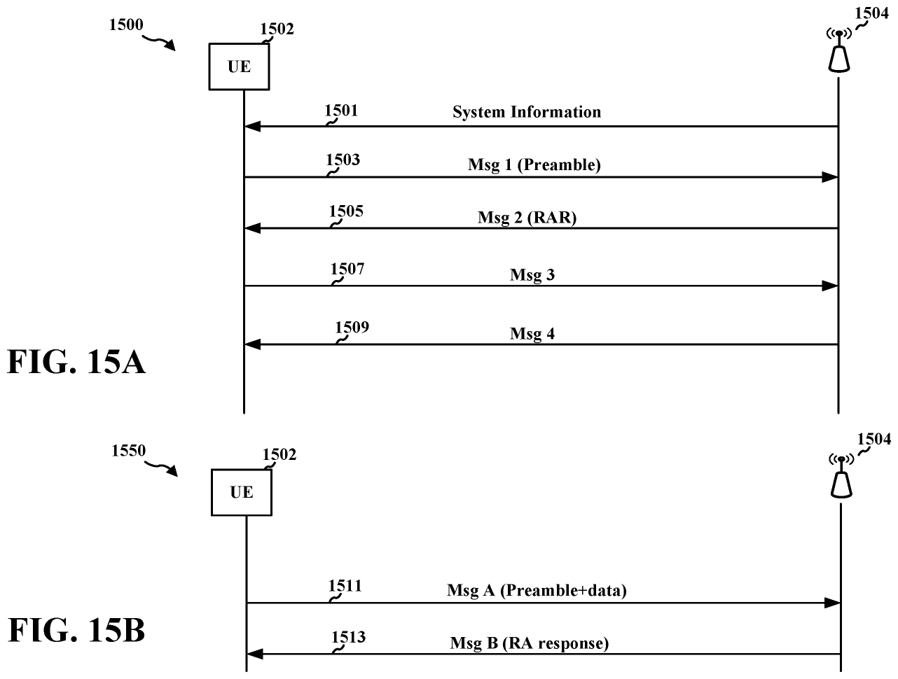

A UE may use a random access procedure in order to communicate with a base station. For example, the UE may use the random access procedure to request an RRC connection, to re-establish an RRC connection, resume an RRC connection, etc. FIGS. 15A and 15B illustrate example aspects of a random access procedure 1500 and 1550 between a UE 1502 and a base station 1504. The UE 1502 may initiate the random access message exchange by sending, to the base station 1504, a first random access message 1503 (e.g., Msg 1) including a preamble. Prior to sending the first random access message 1503, the UE may obtain random access parameters, e.g., including preamble format parameters, time and frequency resources, parameters for determining root sequences and/or cyclic shifts for a random access preamble, etc., e.g., in system information 1501 from the base station 1504. The preamble may be transmitted with an identifier, such as a Random Access RNTI (RA-RNTI). The UE 1502 may randomly select a random access preamble sequence, e.g., from a set of preamble sequences. If the UE 1502 randomly selects the preamble sequence, the base station 1504 may receive another preamble from a different UE at the same time. In some examples, a preamble sequence may be assigned to the UE 1502.

The base station responds to the first random access message 1503 by sending a second random access message 1505 (e.g. Msg 2) using PDSCH and including a random access response (RAR). The RAR may include, e.g., an identifier of the random access preamble sent by the UE, a time advance (TA), an uplink grant for the UE to transmit data, cell radio network temporary identifier (C-RNTI) or other identifier, and/or a back-off indicator. Upon receiving the RAR (e.g., 1505), the UE 1502 may transmit a third random access message 1507 (e.g., Msg 3) to the base station 1504, e.g., using PUSCH, that may include a RRC connection request, an RRC connection re-establishment request, or an RRC connection resume request, depending on the trigger for the initiating the random access procedure. The base station 1504 may then complete the random access procedure by sending a fourth random access message 1509 (e.g., Msg 4) to the UE 1502, e.g., using PDCCH for scheduling and PDSCH for the message. The fourth random access message 1509 may include a random access response message that includes timing advancement information, contention resolution information, and/or RRC connection setup information. The UE 1502 may monitor for PDCCH, e.g., with the C-RNTI. If the PDCCH is successfully decoded, the UE 1502 may also decode PDSCH. The UE 1502 may send HARQ feedback for any data carried in the fourth random access message. If two UEs sent a same preamble at 1503, both UEs may receive the RAR leading both UEs to send a third random access message 1507. The base station 1504 may resolve such a collision by being able to decode the third random access message from only one of the UEs and responding with a fourth random access message to that UE. The other UE, which did not receive the fourth random access message 1509, may determine that random access did not succeed and may re-attempt random access. Thus, the fourth message may be referred to as a contention resolution message. The fourth random access message 1509 may complete the random access procedure. Thus, the UE 1502 may then transmit uplink communication and/or receive downlink communication with the base station 1504 based on the RAR (e.g., 1509).

In order to reduce latency or control signaling overhead, a single round trip cycle between the UE and the base station may be achieved in a 2-step RACH process 1550, such as shown in FIG. 15B. Aspects of Msg 1 and Msg 3 may be combined in a single message, e.g., which may be referred to as Msg A. The Msg A may include a random access preamble, and may also include a PUSCH transmission, e.g., such as data. The MsgA preambles may be separate from the four step preambles, yet may be transmitted in the same random access occasions (ROs) as the preambles of the four step RACH procedure or may be transmitted in separate ROs. The PUSCH transmissions may be transmitted in PUSCH occasions (POs) that may span multiple symbols and PRBs. After the UE 1502 transmits the Msg A 1511, the UE 1502 may wait for a response from the base station 1504. Additionally, aspects of the Msg 2 and Msg 4 may be combined into a single message, which may be referred to as Msg B. Two step RACH may be triggered for reasons similar to a four-step RACH procedure. If the UE does not receive a response, the UE may retransmit the MsgA or may fall back to a four-step RACH procedure starting with a Msg 1. If the base station detects the Msg A, but fails to successfully decode the Msg A PUSCH, the base station may respond with an allocation of resources for an uplink retransmission of the PUSCH. The UE may fall back to the four step RACH with a transmission of Msg 3 based on the response from the base station and may retransmit the PUSCH from Msg A. If the base station successfully decodes the Msg A and corresponding PUSCH, the base station may reply with an indication of the successful receipt, e.g., as a random access response 1513 that completes the two-step RACH procedure. The Msg B may include the random access response and a contention-resolution message. The contention resolution message may be sent after the base station successfully decodes the PUSCH transmission.

Wireless communication systems may be configured to share available system resources and provide various telecommunication services (e.g., telephony, video, data, messaging, broadcasts, etc.) based on multiple-access technologies that support communication with multiple users. Full duplex operation, in which a wireless device exchanges uplink and downlink communication that overlaps in time, may enable more efficient use of the wireless spectrum. Full duplex operation may include simultaneous transmission and reception in the same frequency range. In some examples, the frequency range may be an mmW frequency range, e.g., frequency range 2 (FR2). In some examples, the frequency range may be a sub-6 GHz frequency range, e.g., frequency range 1 (FR1). Full duplex communication may reduce latency. As one example, full duplex operation may enable a base station to transmit a downlink signal in an uplink-only slot, which can reduce the latency for the downlink communication. Full duplex communication may improve spectrum efficiency, e.g., spectrum efficiency per cell or per UE. Full duplex communication may enable more efficient use of wireless resources.

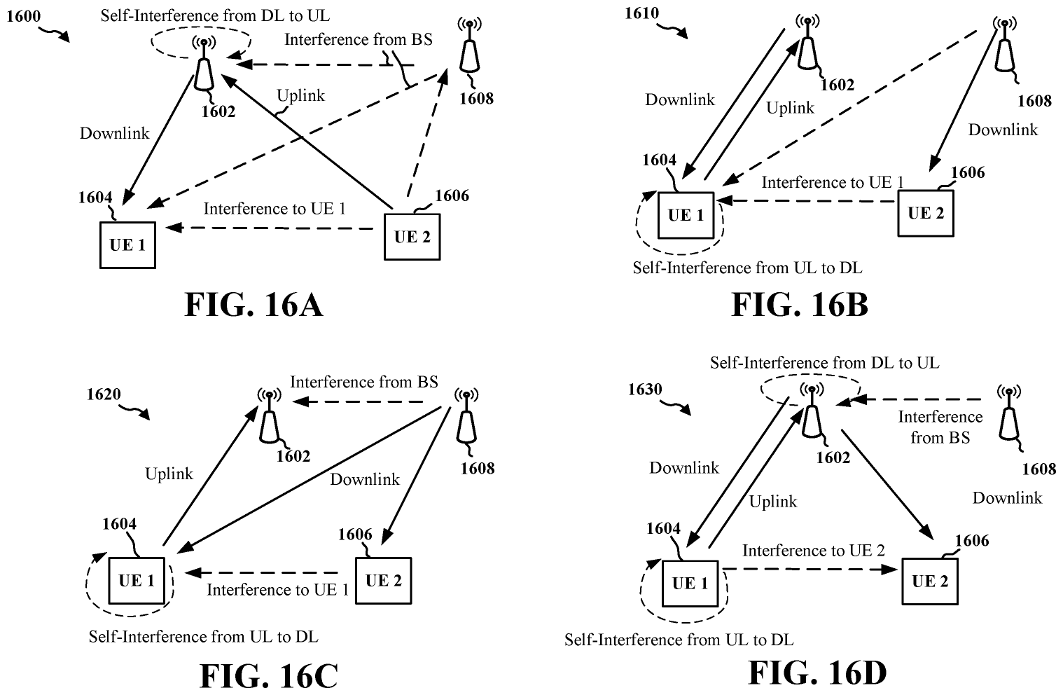

FIGS. 16A, 16B, 16C, and 16D illustrate various modes of full duplex communication. Full duplex communication supports the transmission and reception of information over the same frequency band in a manner that overlaps in time. In this manner, spectral efficiency may be improved with respect to the spectral efficiency of half-duplex communication, which supports the transmission or reception of information in one direction at a time without overlapping uplink and downlink communication. Due to the simultaneous Tx/Rx nature of full duplex communication, a UE or a base station may experience self-interference caused by signal leakage from its local transmitter to its local receiver and/or experienced as clutter from a reflection of the transmitted signal (e.g., due to a reflection from a physical object) that is received as interference to the receiver. In addition, the UE or base station may also experience interference from other devices, such as transmissions from a second UE or a second base station. Such interference (e.g., self-interference or interference caused by other devices) may impact the quality of the communication or even lead to a loss of information.

FIG. 16A shows the first example of full duplex communication 1600 in which a first base station 1602 is in full duplex communication with a first UE 1604 and a second UE 1606. The first UE 1604 and the second UE 1606 may be configured for half-duplex communication or full-duplex communication. FIG. 16A illustrates the first UE 1604 performing downlink reception, and the second UE 1606 performing uplink transmission. The second UE 1606 may transmit a first uplink signal to the first base station 1602 as well as to other base stations, such as a second base station 1608 in proximity to the second UE 1606. The first base station 1602 transmits a downlink signal to the first UE 1604 concurrently (e.g., overlapping at least partially in time) with receiving the uplink signal from the second UE 1606. The base station 1602 may experience self-interference at its receiving antenna that is receiving the uplink signal from UE 1606, the self-interference being due to reception of at least part of the downlink signal transmitted to the UE 1604. The base station 1602 may experience additional interference due to signals from the second base station 1608. Interference may also occur at the first UE 1604 based on signals from the second base station 1608 as well as from uplink signals from the second UE 1606.

FIG. 16B shows the second example of full-duplex communication 1610 in which a first base station 1602 is in full-duplex communication with a first UE 1604. In this example, the UE 1604 is also operating in a full-duplex mode. The first base station 1602 and the UE 1604 receive and transmit communication that overlaps in time and is in the same frequency band. FIG. 16C shows the third example of full-duplex communication 1620 in which a first UE 1604 transmits and receives full-duplex communication with a first base station 1602 and a second base station 1608. The first base station 1602 and the second base station 1608 may serve as multiple transmission and reception points (multi-TRPs) for UL and DL communication with the UE 1604. FIG. 16D shows the fourth example of full-duplex communication 1630 in which a first base station 1602 employs full-duplex communication with a first UE 1604, and transmits downlink communication to a second UE 1606. In this example, the first UE 1604 is operating in a full-duplex mode, and the second UE 1606 is operating in a half-duplex mode.

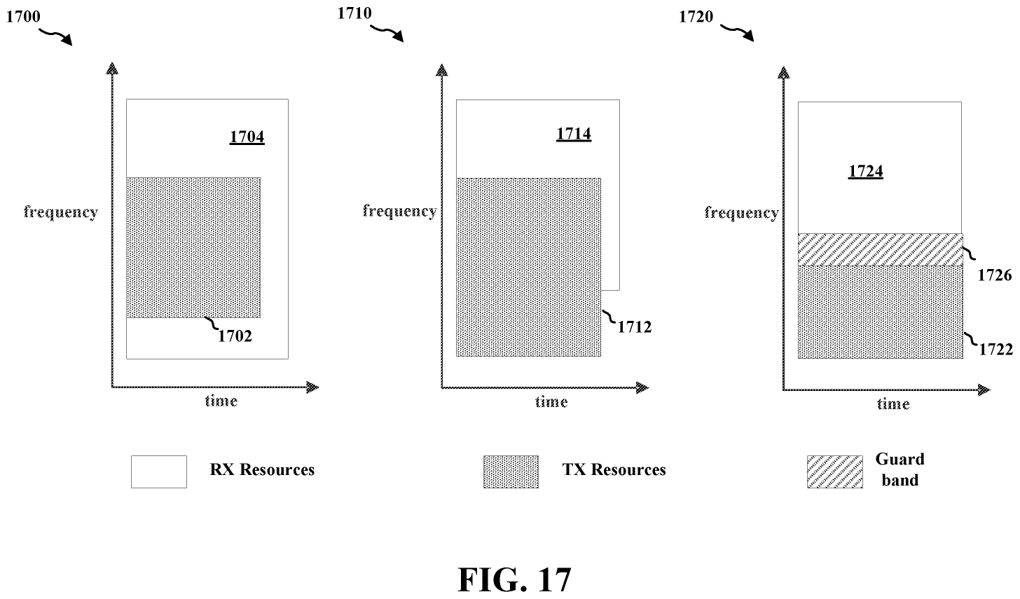

Full duplex communication may be in the same frequency band. The uplink and downlink communication may be in different frequency sub-bands, in the same frequency sub-band, or in partially overlapping frequency sub-bands. FIG. 17 illustrates a first example 1700 and a second example 1710 of in-band full-duplex (IBFD) resources and a third example 1720 of sub-band full-duplex (SBFD) resources. In IBFD, signals may be transmitted and received in overlapping times and overlapping in frequency. As shown in the first example 1700, a time and a frequency allocation of transmission resources 1702 may fully overlap with a time and a frequency allocation of reception resources 1704. In the second example 1710, a time and a frequency allocation of transmission resources 1712 may partially overlap with a time and a frequency of allocation of reception resources 1714.

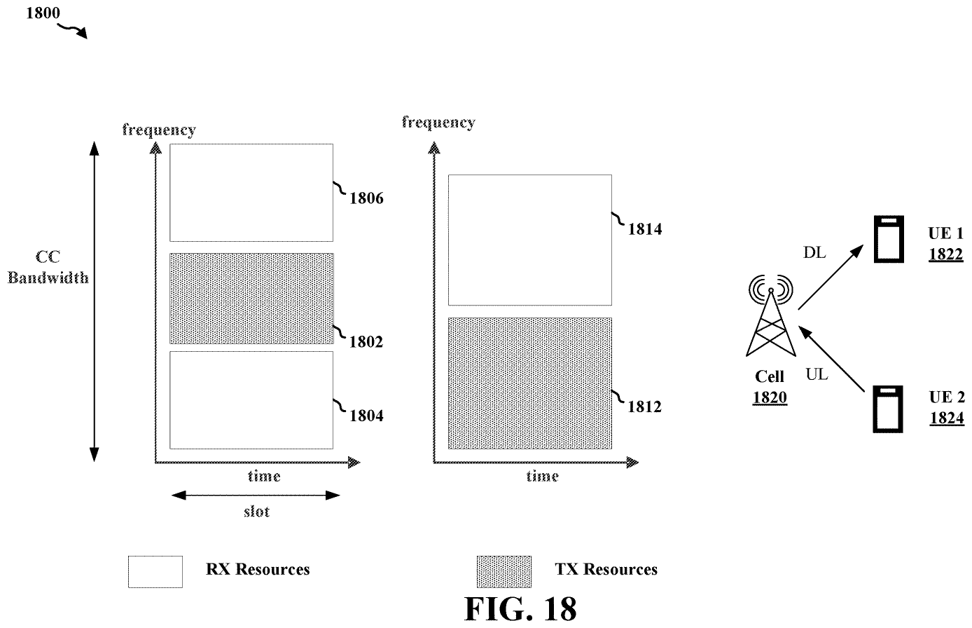

IBFD is in contrast to sub-band FD (SBFD), where transmission and reception resources may overlap in time using different frequencies, as shown in the third example 1720. In the third example 1720, the UL, the transmission resources 1722 are separated from the reception resources 1724 by a guard band 1726. The guard band may be frequency resources, or a gap in frequency resources, provided between the transmission resources 1722 and the reception resources 1724. Separating the transmission frequency resources and the reception frequency resources with a guard band may help to reduce self-interference. Transmission resources and reception resources that are immediately adjacent to each other may be considered as having a guard band width of 0. As an output signal from a wireless device may extend outside the transmission resources, the guard band may reduce interference experienced by the wireless device. Sub-band FDD may also be referred to as “flexible duplex”. SBFD supports simultaneous Tx/Rx of DL/UL on a sub-band basis. SBFD may increase the UL duty cycle, leading to latency reduction and improvement in UL coverage. For example, under SBFD, a UL signal may be transmitted in DL slots or flexible slots, and a DL signal may be received in UL slots, leading to latency savings. SBFD may enhance the system capacity, resource utilization, spectrum efficiency, and enable flexible and dynamic UL/DL resource adaption according to UL/DL traffic in a robust manner. FIG. 18 is a diagram 1800 illustrating an example SBFD operation. As shown in FIG. 18, a cell 1820 may have DL communication with one UE (e.g., UE 1 1822), and simultaneously have UL communication with another UE (e.g., UE 2 1824) on the same slot. In one example, the DL communication with UE 1 1822 may utilize RX resources 1804, 1806, and the UL communication with UE 2 1824 may utilize TX resources 1802. In another example, the DL communication with UE 1 1822 may utilize RX resources 1814, and the UL communication with UE 2 1824 may utilize TX resources 1812.

A UE may receive an indication that some resources are SBFD resources, e.g., that one or more slots or symbols may be used by a base station for SBFD communication. If a UE supports the reception of information indicating SBFD resources, the UE may be referred to as an SBFD-aware UE.

In wireless communications, if random access is allowed in SBFD symbols for SBFD-aware UEs, the random access may potentially reduce the random access latency, reduce the PRACH collision probability, or improve the coverage of PRACH and message 3 (Msg3). PRACH and Msg3 transmissions in uplink subband in SBFD symbols may cause UE-to-UE cross link interference which may impact system performance. It would be desirable to allow random access in SBFD symbols at least for PRACH and Msg3 transmissions in symbols configured as downlink in TDD-UL-DL-ConfigCommon.

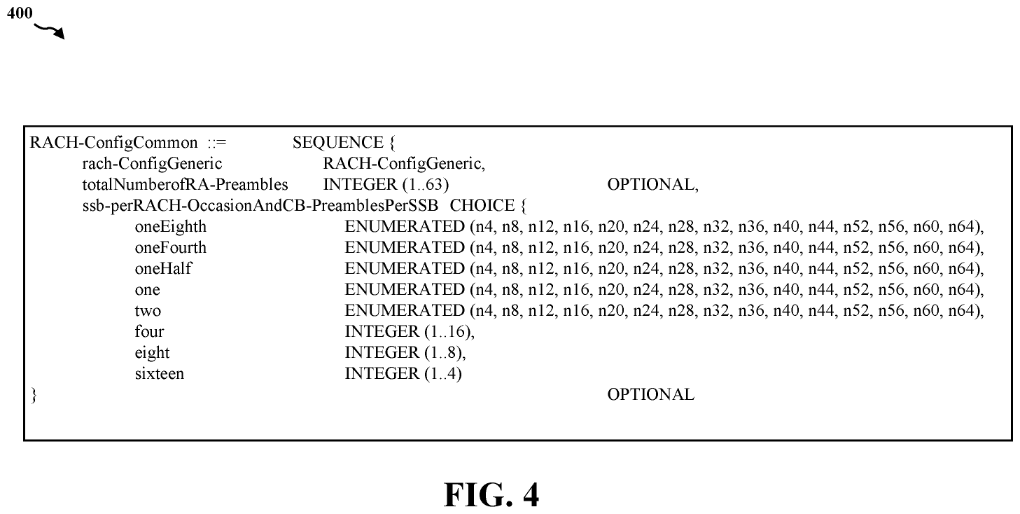

The RACH configuration (e.g., RACH-ConfigCommon) may be indicated in SIB1 and may be used for initial access and for other random access scenarios, such as but not limited to beam failure recovery (BFR) in instances where there are no dedicated BFR configurations. The RACH configuration may determine the parameters utilized to determine the RACH occasions (ROs) number of preambles, the association between SSBs and ROs, or information about time domain allocation and periodicity of ROs, as shown for example in diagram 400 of FIG. 4.

In SBFD slots, the UE may have two sets of RACH occasions, one that is used by SBFD aware UE and one for non-SBFD aware UE. These two sets may come from the same configuration but with different validation rules or may come from two separate configurations which eventually form two sets. Two step RACH may be considered in a similar fashion. The UE may have up to four RACH sets or configurations: half-duplex 4-step RACH, half-duplex 2-step RACH, full duplex 4-step RACH, or full duplex 2-step RACH. Fall back mechanisms from 2-step to 4-step RACH may be based on a maximum number of attempts in 2-step RACH and if exceeded the UE falls back to 4-step RACH. It would be desirable for fall back under the four RACH sets or configurations to account for full duplex sets or configurations.

Aspects presented herein provide a configuration for RACH selection and fall back mechanisms in SBFD networks. For example, a UE may select a RACH configuration based at least on a duplex operation (e.g., full duplex or half duplex) or a RACH type (e.g., 2-step or 4-step), such that a fall back mechanism may include duplex mode configurations. At least one advantage of the disclosure is an enhancement to uplink coverage, an improvement to RACH capacity, or a reduction in latency for random access.

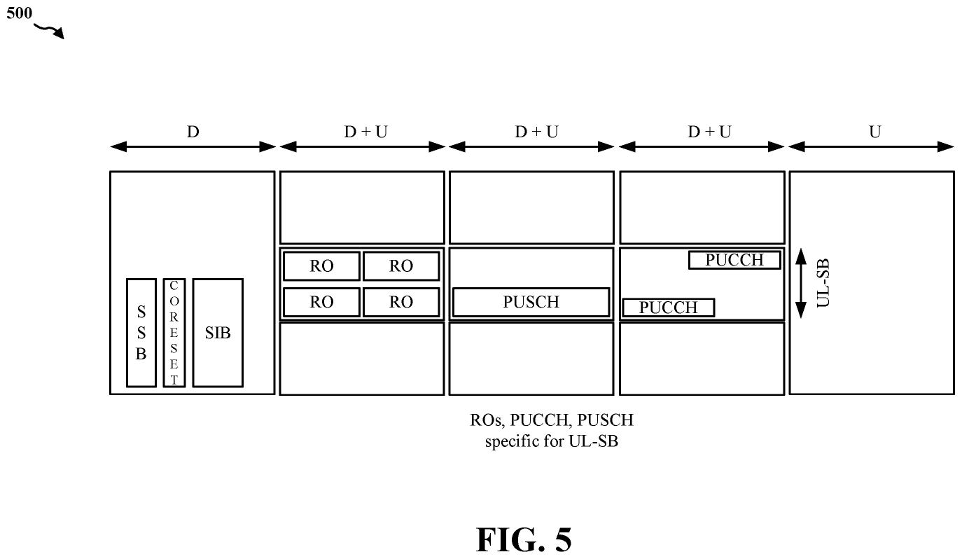

FIG. 5 is a diagram 500 of random access in SBFD resources (e.g., one or more SBFD symbols). Random access in SBFD resources may improve uplink coverage. For example, the UE may utilize the uplink sideband in consecutive SBFD slots to enable message 1 (Msg1) and message 3 (Msg3) repetition and frequency hopping which may enhance the uplink coverage for initial access. In some instances, random access in SBFD symbols may improve RACH capacity. For example, additional ROs may be enabled within the uplink subband which may improve RACH capacity and reduce the contention-based collisions probability while enabling more UEs to access the network. In some instances, random access in SBFD symbols may reduce random access latency. For example, latency may be reduced for random access procedures and potentially for initial access and handover, especially when layer1/layer2 mobility is adopted.

In some instances, such as for subband non-overlapping full duplex operation at the network side within a TDD carrier, a semi-static indication of time location of SBFD subbands may be provided to UEs in RRC_CONNECTED mode. The indication of the time location of SBFD subbands may be provided in SIB. In some instances, a semi-static indication of a frequency domain location of SBFD subbands may be provided to UEs in RRC_CONNECTED mode. The indication of the frequency domain location of SBFD subbands may be provided in SIB. In some instances, SBFD operation to support random access in SBFD symbols by UEs in RRC_CONNECTED mode may be specified to UEs. In some instances, SBFD operation may be configured for UEs in RRC_IDLE mode or RRC_INACTIVE mode for random access.

In some instances, the UE may be configured to select a RACH configuration based on duplex (e.g., full duplex, half duplex) first, then based on type (e.g., 2-step, 4-step). In such instances, the selection of duplex first may be latency based, such that the selection is based on which RACH occasion (RO) is first available. In some instances, such as for 2-step RACH (e.g., as described in the example in FIG. 15B), the UE may be configured with a first threshold for full duplex 2-step RACH, where the first threshold is based on the measurement value of the RSRP of the SSB. For example, the UE may be allowed to perform 2-step RACH in half duplex slots while being allowed to perform only 4-step RACH (e.g., as described in connection with FIG. 15A) in full duplex slots.

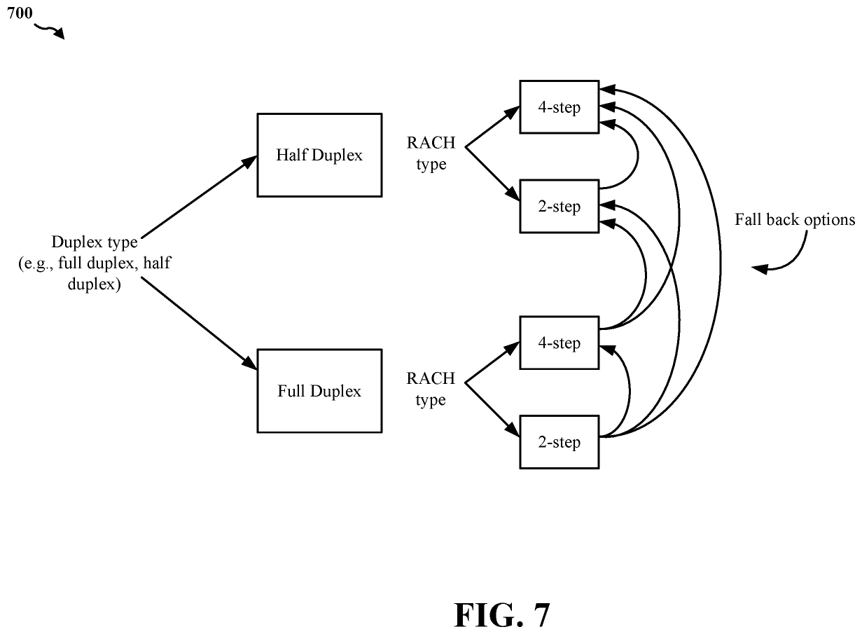

In instances where the duplex type is selected first then the RACH type, as shown for example in diagram 700 of FIG. 7, the UE may fall back based on a limit on full duplex attempts. For example, the UE may attempt to select full duplex and if not successful, the UE may continue to attempt to utilize full duplex. After a certain amount of tries exceed the limit or threshold, the UE may fall back to half duplex. In some aspects, a threshold limit on 2-step RACH attempts may be configured. For example, the UE, after selection of the duplex type, may attempt to utilize 2-step RACH, and if not successful after a certain amount of tries that exceed a limit or threshold, the UE may fall back to 4-step RACH.

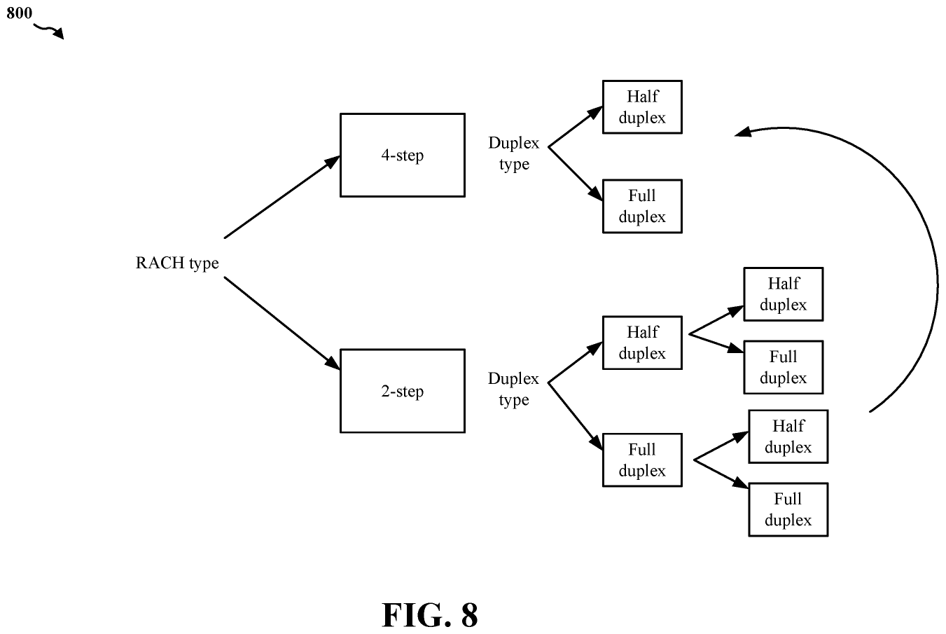

In some aspects, the UE may be configured to select the RACH configuration based on type first, then based on duplex. For example, the UE may select the duplex type based on the measurement value of the RSRP of the SSB in comparison with a second threshold, where the RACH type selection is selected based on the measurement value of the RSRP of the SSB in comparison with a first threshold. When 2-step RACH is allowed in SBFD mode, a msgA preamble and a msgA payload can be transmitted in different slot types forming new possibilities, as shown for example in diagram 800 of FIG. 8. The UE may fall back based on a maximum number of counts for each case. For example, the UE may attempt to select 2-step RACH and if not successful, the UE may continue to attempt to utilize 2-step RACH. After a certain amount of tires exceed the limit or threshold, the UE may fall back to 4-step RACH. In some aspects, a threshold limit on full duplex attempts may be configured. For example, the UE, after selection of the RACH type, may attempt to utilize full duplex, and if not successful after a certain amount of tries, that exceed a limit or threshold, the UE may fall back to half duplex. In instances where the UE falls back from a duplex type to another duplex type (e.g., full duplex to half duplex), the UE may have some power and beam considerations. For example, when the UE falls back from full duplex to half duplex, the UE may reset certain settings (e.g., preamble received target power), or may increment the preamble power from the previous or last transmission. In some aspects, such as when the UE falls back from full duplex to half duplex, the UE may maintain the transmission beam, or may change the transmission beam.

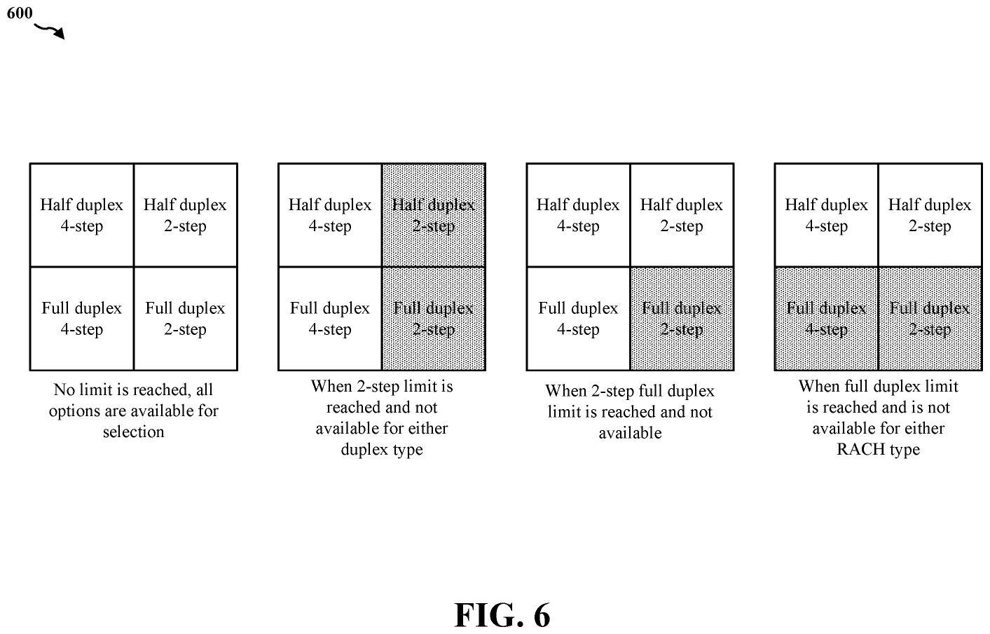

With reference to diagram 600 of FIG. 6, if no limit or threshold has been exceeded, all options with regards to duplex type and RACH type may be available for selection (e.g., half duplex 4-step, half duplex 2-step, full duplex 4-step, full duplex 2-step). In instances, where 2-step limit or threshold has been exceeded or reached, the 2-step option is not available for either duplex type, such that the UE falls back to 4-step RACH (e.g., half duplex 4-step, full duplex 4-step). In instances where 2-step full duplex limit or threshold is reached or exceeded, the full duplex 2-step option is not available and the UE may fall back to at least one of full duplex 4-step, half duplex 4-step, or half duplex 2-step. In instances where the full duplex limit or threshold is reached or exceeded, the full duplex option is not available and the UE may fall back to at least one of half duplex 4-step or half duplex 2-step.

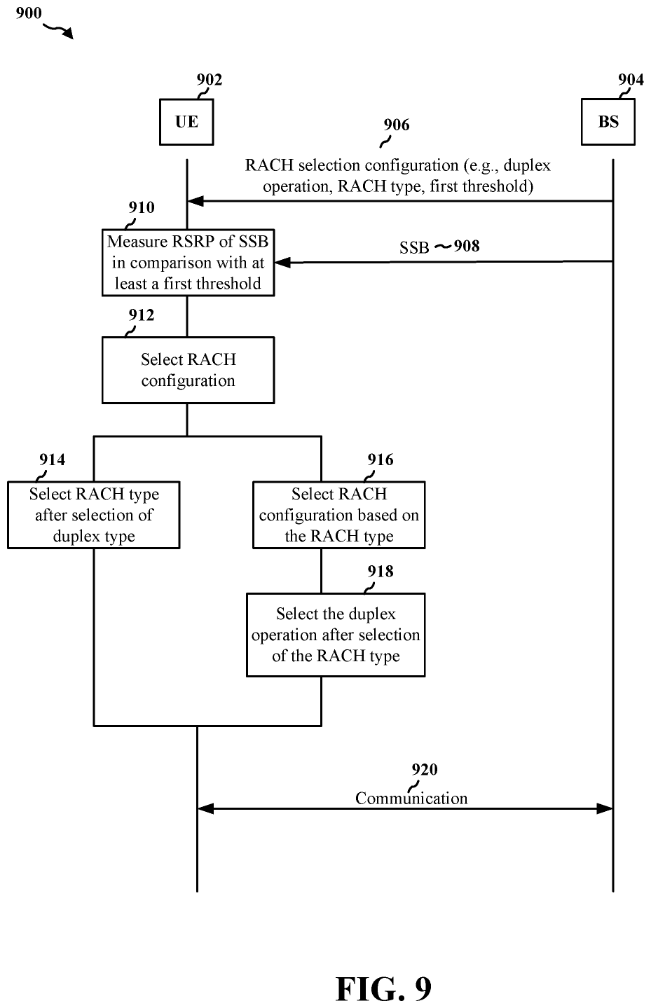

FIG. 9 is a call flow diagram 900 of signaling between a UE 902 and a base station 904. The base station 904 may be configured to provide at least one cell. The UE 902 may be configured to communicate with the base station 904. For example, in the context of FIG. 1, the base station 904 may correspond to base station 102 and the UE 902 may correspond to at least UE 104. In another example, in the context of FIG. 3, the base station 904 may correspond to base station 310 and the UE 902 may correspond to UE 350.

At 906, the base station 904 may provide a RACH selection configuration including instructions to select a RACH configuration based at least on a duplex operation or a RACH type, as described in connection with any of FIGS. 5-8. The base station 904 may provide the RACH selection configuration to the UE 902. The UE 902 may receive the RACH selection configuration from the base station 904. The instructions to select a RACH configuration may be further based on a measurement value of a RSRP in view of at least a first threshold. In some aspects, the RACH type may include a 4-step RACH or a 2-step RACH. In some aspects, the duplex operation includes a full duplex operation or a half-duplex operation.

At 908, the base station may provide a SSB for the UE to measure the RSRP of the SSB, as described in connection with any of FIGS. 5-8. The UE may receive the SSB from the base station. The base station may provide the SSB for the UE to measure, at 910, the RSRP of the SSB in comparison with at least the first threshold, as described in connection with any of FIGS. 5-8.

At 912, the UE 902 may select a RACH configuration, as described in connection with any of FIGS. 5-8. The UE may select the RACH configuration based at least on a duplex operation or a RACH type. The UE may select the RACH configuration further based on a measurement value of the RSRP in view of at least the first threshold. In some aspects, the RACH configuration based on the duplex operation and the RACH type may be selected simultaneously, or may be configured at the UE. In some aspects, a preamble power may be reset or may be incremented based on a last transmission, when the UE performs a fall back based on the duplex operation. In some aspects, a transmission beam of the UE may be maintained or switched, when the UE performs a fall back based on the duplex operation.

At 914, the UE, in some aspects, may select the RACH type after selection of the duplex operation, wherein the RACH type comprises a 4-step RACH or a 2-step RACH, as described in connection with any of FIGS. 5-8. The RACH configuration may be selected based on the duplex operation, wherein the duplex operation comprises a full duplex operation or a half-duplex operation. In some aspects, a selection of the RACH type may be based on a comparison of the measurement value of the RSRP and a second threshold. In some aspects, the 2-step RACH may be selected in response to the measurement value of the RSRP being greater than the second threshold. The 4-step RACH may be selected in response to the measurement value of the RSRP being less than the second threshold. In some aspects, the RACH type includes the 2-step RACH. In such instances, a third threshold may be configured to allow for full-duplex 2-step RACH. The measurement value of the RSRP may be compared with the third threshold. In some aspects, the UE may perform the 2-step RACH in half-duplex slots, and may perform the 4-step RACH in full-duplex slots. In some aspects, the UE falls back to the half-duplex operation in response to a number of full-duplex attempts exceeding a threshold number of attempts. In some aspects, the UE falls back to the 4-step RACH in response to a number of 2-step RACH attempts exceeding a threshold number of attempts.

At 916, the UE, in some aspects, may select the RACH configuration based on the RACH type, as described in connection with any of FIGS. 5-8. The RACH type includes a 2-step RACH or a 4-step RACH. In some aspects, the RACH type comprises the 2-step RACH, wherein a third threshold may be configured to allow for full-duplex 2-step RACH. The measurement value of the RSRP may be compared with the third threshold. In some aspects, the UE falls back to the 4-step RACH in response to a number of 2-step RACH attempts exceeding a threshold number of attempts.

At 918, the UE may select the duplex operation after selection of the RACH type, as described in connection with any of FIGS. 5-8. The duplex operation includes a full-duplex operation or a half-duplex operation. In some aspects, a selection of the duplex operation may be based on a comparison of the measurement value of the RSRP and a second threshold. In some aspects, the full-duplex operation may be selected in response to the measurement value of the RSRP being greater than the second threshold. In such instances, the half-duplex may be selected in response to the measurement value of the RSRP being less than the second threshold. In some aspects, the UE falls back to the half-duplex operation in response to a number of full-duplex attempts exceeding a threshold number of attempts.

At 920, the UE may communicate with the base station, as described in connection with any of FIGS. 5-8. The UE and base station may communicate with each other based on the RACH configuration selected by the UE based at least on the duplex operation or the RACH type.

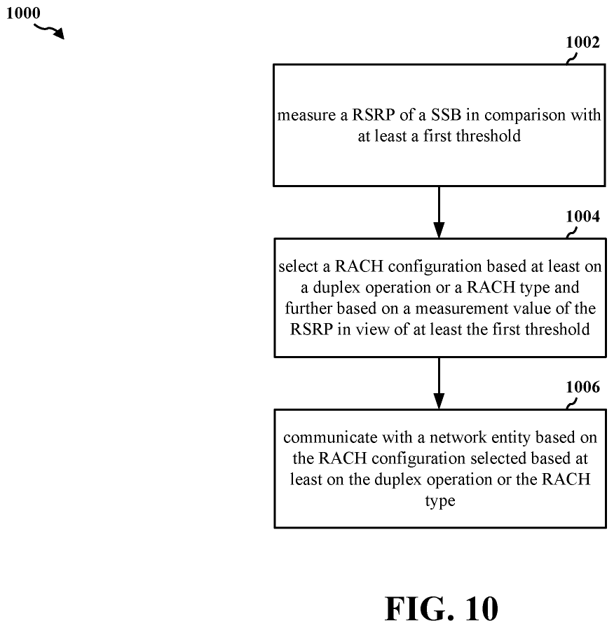

FIG. 10 is a flowchart 1000 of a method of wireless communication. The method may be performed by a UE (e.g., the UE 104; the apparatus 1204). One or more of the illustrated operations may be omitted, transposed, or contemporaneous. The method may configure a UE with fall back mechanisms that include duplex mode configurations.

At 1002, the UE may measure a RSRP of a SSB, as described in connection with any of FIGS. 5-8. For example, 1002 may be performed by RACH component 198 of apparatus 1204. The UE may measure the RSRP of the SSB in comparison with at least a first threshold.

At 1004, the UE may select a RACH configuration, as described in connection with any of FIGS. 5-8. For example, 1004 may be performed by RACH component 198 of apparatus 1204. The UE may select the RACH configuration based at least on a duplex operation or a RACH type. The UE may select the RACH configuration further based on a measurement value of the RSRP in view of at least the first threshold. In some aspects, the RACH configuration based on the duplex operation and the RACH type may be selected simultaneously, or may be configured at the UE. In some aspects, a preamble power may be reset or may be incremented based on a last transmission, when the UE performs a fall back based on the duplex operation. In some aspects, a transmission beam of the UE may be maintained or switched, when the UE performs a fall back based on the duplex operation.

At 1006, the UE may communicate with a network entity, as described in connection with any of FIGS. 5-8. For example, 1006 may be performed by RACH component 198 of apparatus 1204. The UE may communicate with the network entity based on the RACH configuration selected based at least on the duplex operation or the RACH type.

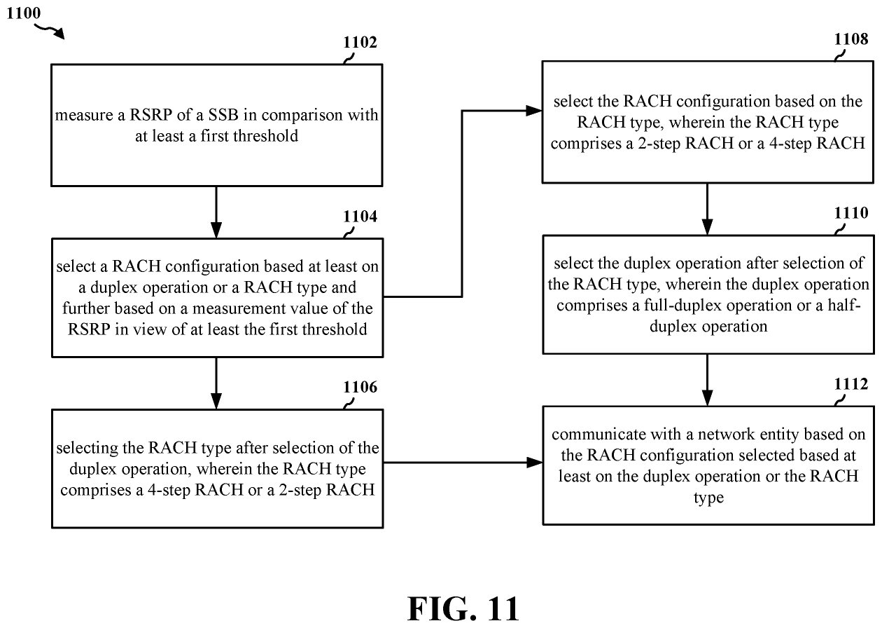

FIG. 11 is a flowchart 1100 of a method of wireless communication. The method may be performed by a UE (e.g., the UE 104; the apparatus 1204). One or more of the illustrated operations may be omitted, transposed, or contemporaneous. The method may configure a UE with fall back mechanisms that include duplex mode configurations.

At 1102, the UE may measure a RSRP of a SSB, as described in connection with any of FIGS. 5-8. For example, 1002 may be performed by RACH component 198 of apparatus 1204. The UE may measure the RSRP of the SSB in comparison with at least a first threshold.

At 1104, the UE may select a RACH configuration, as described in connection with any of FIGS. 5-8. For example, 1004 may be performed by RACH component 198 of apparatus 1204. The UE may select the RACH configuration based at least on a duplex operation or a RACH type. The UE may select the RACH configuration further based on a measurement value of the RSRP in view of at least the first threshold. In some aspects, the RACH configuration based on the duplex operation and the RACH type may be selected simultaneously, or may be configured at the UE. In some aspects, a preamble power may be reset or may be incremented based on a last transmission, when the UE performs a fall back based on the duplex operation. In some aspects, a transmission beam of the UE may be maintained or switched, when the UE performs a fall back based on the duplex operation.

At 1106, the UE may select the RACH type after selection of the duplex operation, wherein the RACH type comprises a 4-step RACH or a 2-step RACH, as described in connection with any of FIGS. 5-8. For example, 1106 may be performed by RACH component 198 of apparatus 1204. The RACH configuration may be selected based on the duplex operation, wherein the duplex operation comprises a full duplex operation or a half-duplex operation. In some aspects, a selection of the RACH type may be based on a comparison of the measurement value of the RSRP and a second threshold. In some aspects, the 2-step RACH may be selected in response to the measurement value of the RSRP being greater than the second threshold. The 4-step RACH may be selected in response to the measurement value of the RSRP being less than the second threshold. In some aspects, the RACH type includes the 2-step RACH. In such instances, a third threshold may be configured to allow for full-duplex 2-step RACH. The measurement value of the RSRP may be compared with the third threshold. In some aspects, the UE may perform the 2-step RACH in half-duplex slots, and may perform the 4-step RACH in full-duplex slots. In some aspects, the

UE falls back to the half-duplex operation in response to a number of full-duplex attempts exceeding a threshold number of attempts. In some aspects, the UE falls back to the 4-step RACH in response to a number of 2-step RACH attempts exceeding a threshold number of attempts.

At 1108, the UE may select the RACH configuration based on the RACH type, as described in connection with any of FIGS. 5-8. For example, 1108 may be performed by RACH component 198 of apparatus 1204. The RACH type includes a 2-step RACH or a 4-step RACH. In some aspects, the RACH type comprises the 2-step RACH, wherein a third threshold may be configured to allow for full-duplex 2-step RACH. The measurement value of the RSRP may be compared with the third threshold. In some aspects, the UE falls back to the 4-step RACH in response to a number of 2-step RACH attempts exceeding a threshold number of attempts.

At 1110, the UE may select the duplex operation after selection of the RACH type, as described in connection with any of FIGS. 5-8. For example, 1110 may be performed by RACH component 198 of apparatus 1204. The duplex operation includes a full-duplex operation or a half-duplex operation. In some aspects, a selection of the duplex operation may be based on a comparison of the measurement value of the RSRP and a second threshold. In some aspects, the full-duplex operation may be selected in response to the measurement value of the RSRP being greater than the second threshold. In such instances, the half-duplex may be selected in response to the measurement value of the RSRP being less than the second threshold. In some aspects, the UE falls back to the half-duplex operation in response to a number of full-duplex attempts exceeding a threshold number of attempts.

At 1112, the UE may communicate with a network entity, as described in connection with any of FIGS. 5-8. For example, 1112 may be performed by RACH component 198 of apparatus 1204. The UE may communicate with the network entity based on the RACH configuration selected based at least on the duplex operation or the RACH type.

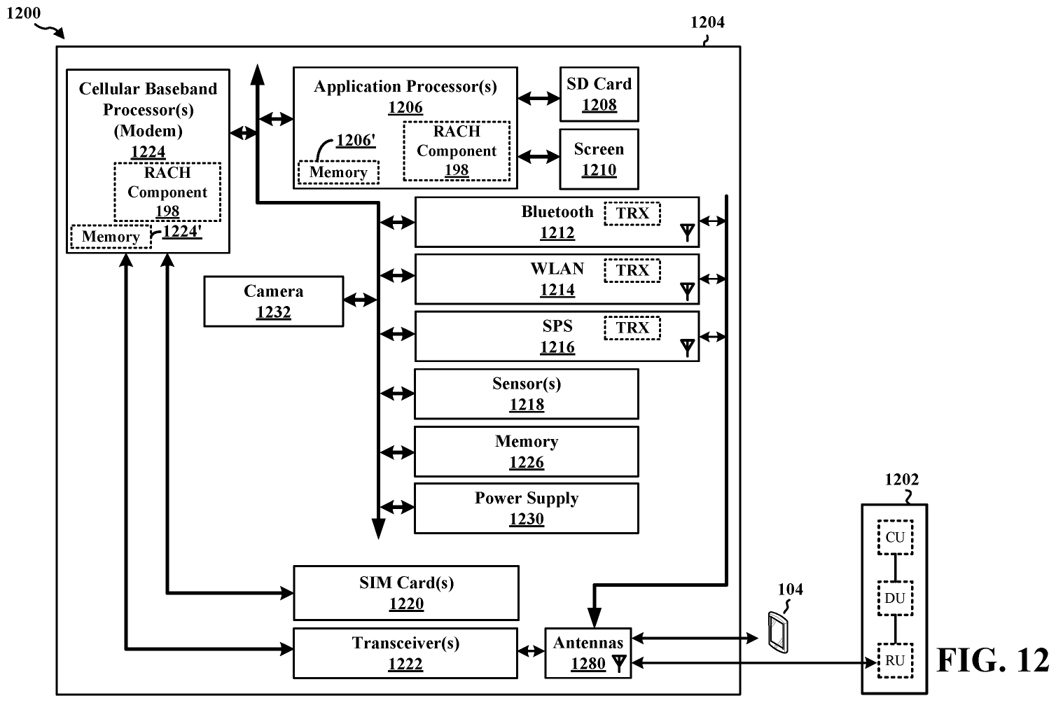

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1006 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the component 198 may be configured to measure a RSRP of a SSB in comparison with at least a first threshold; select a RACH configuration based at least on a duplex operation or a RACH type and further based on a measurement value of the RSRP in view of at least the first threshold; and communicate with a network entity based on the RACH configuration selected based at least on the duplex operation or the RACH type. The component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for measuring a RSRP of a SSB in comparison with at least a first threshold. The apparatus includes means for selecting a RACH configuration based at least on a duplex operation or a RACH type and further based on a measurement value of the RSRP in view of at least the first threshold. The apparatus includes means for communicating with a network entity based on the RACH configuration selected based at least on the duplex operation or the RACH type. The apparatus further includes means for selecting the RACH type after selection of the duplex operation, wherein the RACH type comprises a 4-step RACH or a 2-step RACH. The apparatus further includes means for selecting the RACH configuration based on the RACH type, wherein the RACH type comprises a 2-step RACH or a 4-step RACH. The apparatus further includes means for selecting the duplex operation after selection of the RACH type, wherein the duplex operation comprises a full-duplex operation or a half-duplex operation. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

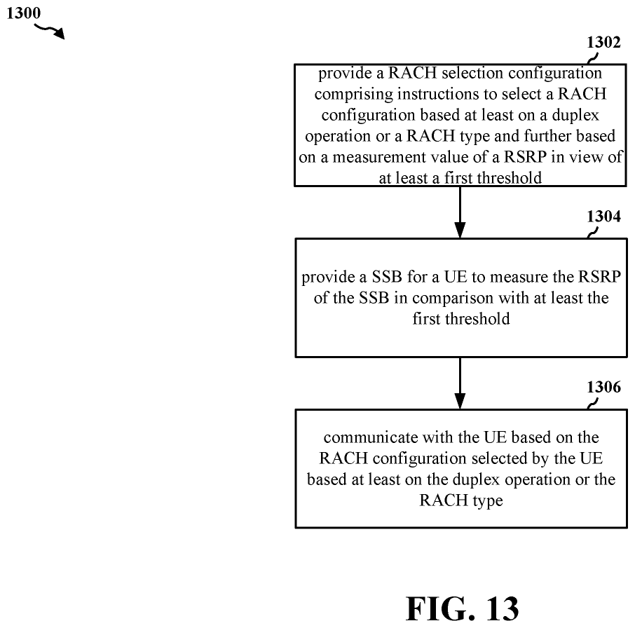

FIG. 13 is a flowchart 1300 of a method of wireless communication at a network entity. The method may be performed by a base station (e.g., the base station 102; the network entity 1402). One or more of the illustrated operations may be omitted, transposed, or contemporaneous. The method may configure a UE with fall back mechanisms that include duplex mode configurations.

At 1302, the network entity may provide a RACH selection configuration, as described in connection with any of FIGS. 5-8. For example, 1302 may be performed by RACH component 199 of network entity 1402. The network entity may provide the RACH selection configuration including instructions to select a RACH configuration based at least on a duplex operation or a RACH type. The instructions to select a RACH configuration may be further based on a measurement value of a RSRP in view of at least a first threshold. In some aspects, the RACH type may include a 4-step RACH or a 2-step RACH. In some aspects, the duplex operation includes a full duplex operation or a half-duplex operation.

At 1304, the network entity may provide a SSB for a UE to measure the RSRP of the SSB, as described in connection with any of FIGS. 5-8. For example, 1304 may be performed by RACH component 199 of network entity 1402. The network entity may provide the SSB for the UE to measure the RSRP of the SSB in comparison with at least the first threshold.

At 1306, the network entity may communicate with the UE, as described in connection with any of FIGS. 5-8. For example, 1306 may be performed by RACH component 199 of network entity 1402. The network entity may communicate with the UE based on the RACH configuration selected by the UE based at least on the duplex operation or the RACH type.

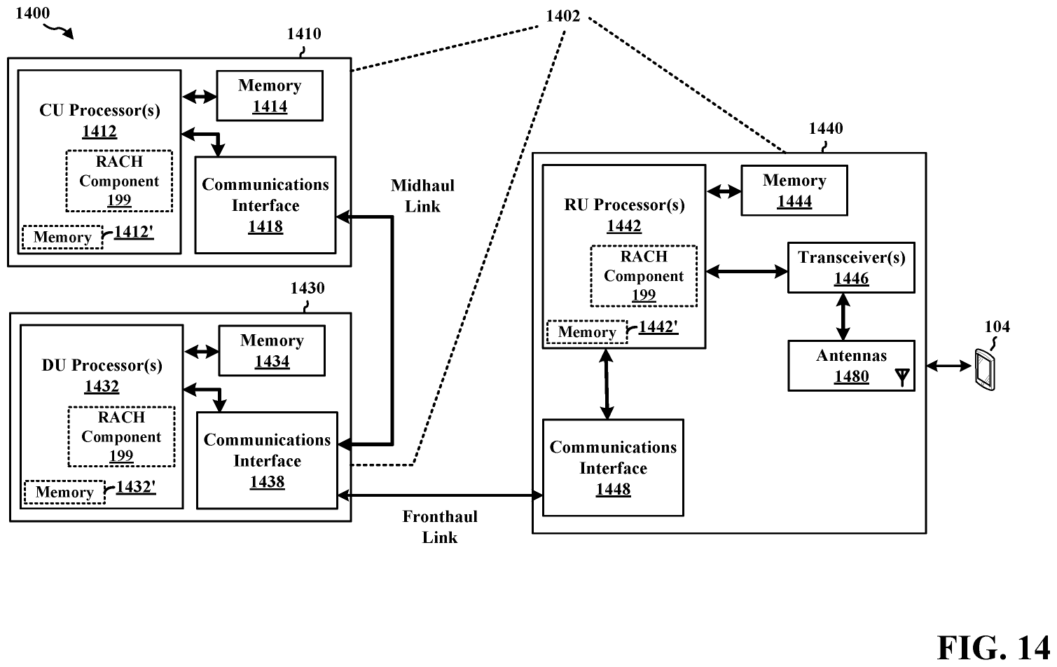

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide a RACH selection configuration comprising instructions to select a RACH configuration based at least on a duplex operation or a RACH type and further based on a measurement value of a RSRP in view of at least a first threshold; provide a SSB for a UE to measure the RSRP of the SSB in comparison with at least the first threshold; and communicate with the UE based on the RACH configuration selected by the UE based at least on the duplex operation or the RACH type. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 may include means for providing a RACH selection configuration comprising instructions to select a RACH configuration based at least on a duplex operation or a RACH type and further based on a measurement value of a RSRP in view of at least a first threshold. The network entity includes means for providing a SSB for a UE to measure the RSRP of the SSB in comparison with at least the first threshold. The network entity includes means for communicating with the UE based on the RACH configuration selected by the UE based at least on the duplex operation or the RACH type. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented. The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE comprising measuring a RSRP of a SSB in comparison with at least a first threshold; selecting a RACH configuration based at least on a duplex operation or a RACH type and further based on a measurement value of the RSRP in view of at least the first threshold; and communicating with a network entity based on the RACH configuration selected based at least on the duplex operation or the RACH type.
Aspect 2 is the method of aspect 1, further includes that the RACH configuration is selected based on the duplex operation, wherein the duplex operation comprises a full duplex operation or a half-duplex operation further including selecting the RACH type after selection of the duplex operation, wherein the RACH type comprises a 4-step RACH or a 2-step RACH.
Aspect 3 is the method of any of aspects 1 and 2, further includes that a second selection of the RACH type is based on a second comparison of the measurement value of the RSRP and a second threshold.
Aspect 4 is the method of any of aspects 1-3, further includes that the 2-step RACH is selected in response to the measurement value of the RSRP being greater than the second threshold, wherein the 4-step RACH is selected in response to the measurement value of the RSRP being less than the second threshold.
Aspect 5 is the method of any of aspects 1-4, further includes that the RACH type comprises the 2-step RACH, wherein a third threshold is configured to allow for full-duplex 2-step RACH, wherein the measurement value of the RSRP is compared with the third threshold.
Aspect 6 is the method of any of aspects 1-5, further includes that the UE performs the 2-step RACH in half-duplex slots, and performs the 4-step RACH in full-duplex slots.
Aspect 7 is the method of any of aspects 1-6, further includes that the UE falls back to the half-duplex operation in response to a number of full-duplex attempts exceeding a threshold number of attempts.
Aspect 8 is the method of any of aspects 1-7, further includes that the UE falls back to the 4-step RACH in response to a number of 2-step RACH attempts exceeding a threshold number of attempts.
Aspect 9 is the method of any of aspects 1-8, further including selecting the RACH configuration based on the RACH type, wherein the RACH type comprises a 2-step RACH or a 4-step RACH; and selecting the duplex operation after selection of the RACH type, wherein the duplex operation comprises a full-duplex operation or a half-duplex operation.
Aspect 10 is the method of any of aspects 1-9, further includes that a second selection of the duplex operation is based on a second comparison of the measurement value of the RSRP and a second threshold.
Aspect 11 is the method of any of aspects 1-10, further includes that the full-duplex operation is selected in response to the measurement value of the RSRP being greater than the second threshold, wherein the half-duplex operation is selected in response to the measurement value of the RSRP being less than the second threshold.
Aspect 12 is the method of any of aspects 1-11, further includes that the RACH type comprises the 2-step RACH, wherein a third threshold is configured to allow for full-duplex 2-step RACH, wherein the measurement value of the RSRP is compared with the third threshold.
Aspect 13 is the method of any of aspects 1-12, further includes that the UE falls back to the 4-step RACH in response to a number of 2-step RACH attempts exceeding a threshold number of attempts.
Aspect 14 is the method of any of aspects 1-13, further includes that the UE falls back to the half-duplex operation in response to a number of full-duplex attempts exceeding a threshold number of attempts.
Aspect 15 is the method of any of aspects 1-14, further includes that the RACH configuration based on the duplex operation and the RACH type are selected simultaneously, or is configured at the UE.
Aspect 16 is the method of any of aspects 1-15, further includes that a preamble power is reset or is incremented based on a last transmission, when the UE performs a fall back based on the duplex operation.
Aspect 17 is the method of any of aspects 1-16, further includes that a transmission beam of the UE is maintained or switched, when the UE performs a fall back based on the duplex operation.
Aspect 18 is an apparatus for wireless communication at a UE including at least one processor coupled to a memory and at least one transceiver, the at least one processor configured to implement any of aspects 1-17.
Aspect 19 is an apparatus for wireless communication at a UE including means for implementing any of aspects 1-17.
Aspect 20 is a computer-readable medium storing computer executable code, where the code when executed by a processor causes the processor to implement any of aspects 1-17.
Aspect 21 is a method of wireless communication at a network entity comprising providing a RACH selection configuration comprising instructions to select a RACH configuration based at least on a duplex operation or a RACH type and further based on a measurement value of a RSRP in view of at least a first threshold; providing a SSB for a UE to measure the RSRP of the SSB in comparison with at least the first threshold; and communicating with the UE based on the RACH configuration selected by the UE based at least on the duplex operation or the RACH type.
Aspect 22 is the method of aspect 21, further includes that the RACH type comprises a 4-step RACH or a 2-step RACH, wherein the duplex operation comprises a full duplex operation or a half-duplex operation.
Aspect 23 is an apparatus for wireless communication at a network entity including at least one processor coupled to a memory and at least one transceiver, the at least one processor configured to implement any of aspects 21-22.
Aspect 24 is an apparatus for wireless communication at a network entity including means for implementing any of aspects 21-22.
Aspect 25 is a computer-readable medium storing computer executable code, where the code when executed by a processor causes the processor to implement any of aspects 21-22.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the apparatus to:
measure a reference signal received power (RSRP) of a synchronization signal block (SSB) in comparison with at least a first threshold;
select a random access channel (RACH) configuration based at least on a duplex operation or a RACH type and further based on a measurement value of the RSRP in view of at least the first threshold; and
communicate with a network entity based on the RACH configuration selected based at least on the duplex operation or the RACH type.

2. The apparatus of claim 1, further comprising a transceiver coupled to the at least one processor, the transceiver being configured to:
communicate with the network entity based on the RACH configuration selected based at least on the duplex operation or the RACH type.

3. The apparatus of claim 1, wherein the RACH configuration is selected based on the duplex operation, wherein the duplex operation comprises a full duplex operation or a half-duplex operation, wherein the at least one processor is configured to:
select the RACH type after selection of the duplex operation, wherein the RACH type comprises a 4-step RACH or a 2-step RACH.

4. The apparatus of claim 3, wherein a second selection of the RACH type is based on a second comparison of the measurement value of the RSRP and a second threshold.

5. The apparatus of claim 4, wherein the 2-step RACH is selected in response to the measurement value of the RSRP being greater than the second threshold, wherein the 4-step RACH is selected in response to the measurement value of the RSRP being less than the second threshold.

6. The apparatus of claim 3, wherein the RACH type comprises the 2-step RACH, wherein a third threshold is configured to allow for full-duplex 2-step RACH, wherein the measurement value of the RSRP is compared with the third threshold.

7. The apparatus of claim 6, wherein the UE performs the 2-step RACH in half-duplex slots, and performs the 4-step RACH in full-duplex slots.

8. The apparatus of claim 3, wherein the UE falls back to the half-duplex operation in response to a number of full-duplex attempts exceeding a threshold number of attempts.

9. The apparatus of claim 3, wherein the UE falls back to the 4-step RACH in response to a number of 2-step RACH attempts exceeding a threshold number of attempts.

10. The apparatus of claim 1, wherein the at least one processor is configured to:
select the RACH configuration based on the RACH type, wherein the RACH type comprises a 2-step RACH or a 4-step RACH; and
select the duplex operation after selection of the RACH type, wherein the duplex operation comprises a full-duplex operation or a half-duplex operation.

11. The apparatus of claim 10, wherein a second selection of the duplex operation is based on a second comparison of the measurement value of the RSRP and a second threshold.

12. The apparatus of claim 11, wherein the full-duplex operation is selected in response to the measurement value of the RSRP being greater than the second threshold, wherein the half-duplex operation is selected in response to the measurement value of the RSRP being less than the second threshold.

13. The apparatus of claim 10, wherein the RACH type comprises the 2-step RACH, wherein a third threshold is configured to allow for full-duplex 2-step RACH, wherein the measurement value of the RSRP is compared with the third threshold.

14. The apparatus of claim 10, wherein the UE falls back to the 4-step RACH in response to a number of 2-step RACH attempts exceeding a threshold number of attempts.

15. The apparatus of claim 10, wherein the UE falls back to the half-duplex operation in response to a number of full-duplex attempts exceeding a threshold number of attempts.

16. The apparatus of claim 1, wherein the RACH configuration based on the duplex operation and the RACH type are selected simultaneously, or is configured at the UE.

17. The apparatus of claim 1, wherein a preamble power is reset or is incremented based on a last transmission, when the UE performs a fall back based on the duplex operation.

18. The apparatus of claim 1, wherein a transmission beam of the UE is maintained or switched, when the UE performs a fall back based on the duplex operation.

19. A method of wireless communication at a user equipment (UE), comprising:
measuring a reference signal received power (RSRP) of a synchronization signal block (SSB) in comparison with at least a first threshold;
selecting a random access channel (RACH) configuration based at least on a duplex operation or a RACH type and further based on a measurement value of the RSRP in view of at least the first threshold; and
communicating with a network entity based on the RACH configuration selected based at least on the duplex operation or the RACH type.

20. The method of claim 19, wherein the RACH configuration is selected based on the duplex operation, wherein the duplex operation comprises a full duplex operation or a half-duplex operation, the method further comprising:
selecting the RACH type after selecting the duplex operation, wherein the RACH type comprises a 4-step RACH or a 2-step RACH.

21. The method of claim 20, wherein a selection of the RACH type is based on a second comparison of the measurement value of the RSRP and a second threshold, wherein the 2-step RACH is selected in response to the measurement value of the RSRP being greater than the second threshold, wherein the 4-step RACH is selected in response to the measurement value of the RSRP being less than the second threshold.

22. The method of claim 20, wherein the RACH type comprises the 2-step RACH, wherein a third threshold is configured to allow for full-duplex 2-step RACH, wherein the measurement value of the RSRP is compared with the third threshold, wherein the UE performs the 2-step RACH in half-duplex slots, and performs the 4-step RACH in full-duplex slots.

23. The method of claim 19, further comprising:
selecting the RACH configuration based on the RACH type, wherein the RACH type comprises a 2-step RACH or a 4-step RACH; and
selecting the duplex operation after selecting the RACH type, wherein the duplex operation comprises a full-duplex operation or a half-duplex operation.

24. The method of claim 23, wherein a selection of the duplex operation is based on a comparison of the measurement value of the RSRP and a second threshold.

25. The method of claim 24, wherein the full-duplex operation is selected in response to the measurement value of the RSRP being greater than the second threshold, wherein the half-duplex operation is selected in response to the measurement value of the RSRP being less than the second threshold.

26. The method of claim 19, wherein the RACH configuration based on the duplex operation and the RACH type are selected simultaneously, or is configured at the UE.

27. An apparatus for wireless communication at a network entity, comprising:
at least one memory; and
at least one processor coupled to the at least one memory and, based at least in part on information stored in the at least one memory, the at least one processor, individually or in any combination, is configured to cause the apparatus to:
provide a random access channel (RACH) selection configuration comprising instructions to select a RACH configuration based at least on a duplex operation or a RACH type and further based on a measurement value of a reference signal received power (RSRP) in view of at least a first threshold;
provide a synchronization signal block (SSB) for a user equipment (UE) to measure the RSRP of the SSB in comparison with at least the first threshold; and
communicate with the UE based on the RACH configuration selected by the UE based at least on the duplex operation or the RACH type.

28. The apparatus of claim 27, further comprising a transceiver coupled to the at least one processor, the transceiver being configured to:
provide the RACH selection configuration comprising the instructions to select the RACH configuration based at least on the duplex operation or the RACH type and further based on the measurement value of the RSRP in view of at least the first threshold;
provide the SSB for the UE to measure the RSRP of the SSB in comparison with at least the first threshold; and
communicate with the UE based on the RACH configuration selected by the UE based at least on the duplex operation or the RACH type.

29. The apparatus of claim 28, wherein the RACH type comprises a 4-step RACH or a 2-step RACH, wherein the duplex operation comprises a full duplex operation or a half-duplex operation.

30. A method of wireless communication at a network entity, comprising:
providing a random access channel (RACH) selection configuration comprising instructions to select a RACH configuration based at least on a duplex operation or a RACH type and further based on a measurement value of a reference signal received power (RSRP) in view of at least a first threshold;
providing a synchronization signal block (SSB) for a user equipment (UE) to measure the RSRP of the SSB in comparison with at least the first threshold; and
communicating with the UE based on the RACH configuration selected by the UE based at least on the duplex operation or the RACH type.
